(19) United States
(12) Patent Application Publication
(10) Pub. No.: US 2004/0080550 A1
(43) Pub. Date: Apr. 29, 2004

(54) One-molding frame of combination printer

(75) Inventors: Dong-Gyoo Lee, Suwon-city (KR); Yong-Hyun Lee, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/681,176

(22) Filed: Oct. 9, 2003

(30) Foreign Application Priority Data
Oct. 28, 2002 (KR) 2002-65864

(51) Int. Cl. B41J 29/13

(52) U.S. Cl. 347/3; 347/108

(57) ABSTRACT

A one-molding frame for a combination printer has a paper feed module frame, a print module frame, a scan module frame, all being integrally formed in a base frame. The one-molding frame is used in an inkjet combination printer having a pickup roller to separate stacked paper sheet by sheet and feed the separated paper, an inkjet head unit to form an image on paper fed from the pickup roller, and a scan part to read a document. The one-molding frame has a base frame with a conveyance path for the paper formed therein, a paper feed part protruding from one end of an upper surface of the base frame to define a stacker on which plural sheets of paper are stacked, and the paper feed part on which the pickup roller is disposed. A print part, on which the inkjet head unit is disposed, is formed in front of the paper feed part of the base frame, and a scan part protruding from the other end of the upper surface of the base frame, the base frame, the paper feed part, the print part and the scan part being integrally formed.

### CROSS-REFERENCE TO RELATED APPLICATIONS

This application claims the priority of Korean Patent Application No. 2002-65864, filed Oct. 28, 2002 in the Korean Intellectual Property Office, the disclosure of which is incorporated herein by reference.

### BACKGROUND OF THE INVENTION

1. Field of the Invention

The present invention relates to a combination printer having printer, copier and scanner functions, and more particularly, to a one-molding frame of a combination printer, in which the frame to support elements performing each function is integrally formed.

2. Description of the Related Art

A combination printer having printer, copier and scanner functions includes a paper feed module to carry sheets of paper, separate the paper sheet by sheet and feed the separated paper, and a print module to print an image on paper. The combination printer further includes a scan module to read the content of a document, a base frame in which the paper feed module, print module and scan module are disposed and to provide a path for paper or a document passing each module, a cover to cover each module from exposure, and an operation part disposed at a side of the cover to operate the combination printer.

The combination printer can be divided into an inkjet type or a laser type according to the method of printing in the print module. In the inkjet combination printer, a maintenance module can be additionally provided to one side of the print module of the base frame to clean an inkjet head and cap the inkjet head to prevent the inkjet head from getting dry.

It is a general manufacturing method that such a conventional combination printer is a module type in which the respective modules such as the paper feed module, print module, and maintenance module are assembled in the base frame. That is, the paper feed module is manufactured including a stacker to support and stack paper, the feed roller to feed a sheet of paper from the stacker, and a frame to support the stacker and the feed roller, all assembled as a single module which is then assembled into the base frame. Likewise, the print module and the scan module are made in advance as pre-assembled forms and then assembled into the base frame.

Such a module type combination printer needs a separate frame to support each module and is costly since respective modules are separately assembled and then assembled into the base frame.

In addition, the number of parts and work processes increases, increasing manufacturing costs since a frame needs to be individually manufactured for each module and each module is assembled in a separate assembling process.

Therefore, there is a need for a one-molding frame which can reduce the number of parts by integrally forming a frame for all modules of the combination printer.

### SUMMARY OF THE INVENTION

Accordingly, it is an aspect of the present invention to solve the foregoing and/or other problems by providing a one-molding frame for a combination printer which can reduce the number of parts forming the combination printer by integrally forming each frame for a paper feed module, print module, and scan module with a base frame.

Additional aspects and advantages of the invention will be set forth in part in the description which follows and, in part, will be obvious from the description, or may be learned by practice of the invention.

The foregoing and/or other aspects of the present invention may be achieved by providing a one-molding frame for a combination printer including a paper feed module frame to stack a plurality of sheets of paper, separate the stacked papers sheet by sheet and feed the separated papers; a print module frame adjacent the paper feed module to form an image on the fed papers; a scan module frame disposed adjacent to the print module to read a document; and a base frame to support the paper feed module frame, the print module frame, and the scan module frame and to form a conveyance path for the paper, wherein the paper feed module frame, the print module frame, and the scan module frame are integrally formed.

The print module is an inkjet head to perform printing on the paper by spraying ink. The base frame is additionally provided with a maintenance module frame which is integrally formed thereto to clean the inkjet head and prevent ink from getting dry.

The foregoing and/or other aspects may be achieved by providing a one-molding frame used in an inkjet combination printer including a pickup roller to separate stacked paper sheet by sheet and feed the separated paper, an inkjet head unit to form an image on the fed paper, and a scan part to read a document, the one-molding frame including a base frame forming a conveyance path for the paper; a paper feed part protruding from a first end of an upper surface of the base frame to define a stacker on which plural sheets of the paper are stacked, the pickup roller being disposed thereon; a print part adjacent to the paper feed part of the base frame, the inkjet head unit being disposed thereon; and a scan portion protruding from a second end of the upper surface of the base frame opposite the first end, wherein the base frame, the paper feed part, the print part and the scan portion are integrally formed.

The frame further includes a maintenance part formed at one side of the print part, on which a maintenance part is disposed to clean an inkjet head of the inkjet head unit and prevent ink from getting dry.

The scan part is formed on the base frame in a bridge shape and the paper is conveyed between the scan part and the base frame.

The one-molding frame of a combination printer according to the embodiments of the present invention reduces the number of parts for forming the combination printer since each frame for a paper feed module, print module, and scan module is integrally formed with a base frame. Furthermore, the number of assembling processes can be reduced since the parts forming each module are directly assembled into the base frame. Therefore, a one-molding frame for a combination printer with reduced material costs, assembling costs and manufacturing management costs is provided.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view showing a one-molding frame for an inkjet combination printer according to an embodiment of the present invention; and

FIG. 2 is a perspective view showing the one-molding frame of FIG. 1 with the elements for paper-feeding, printing and scanning functions being assembled therein.

### DETAILED DESCRIPTION OF THE PREFERRED EMBODIMENT

Reference will now be made in detail to the present preferred embodiment of the present invention, examples of which are illustrated in the accompanying drawings, wherein like reference numerals refer to like elements throughout.

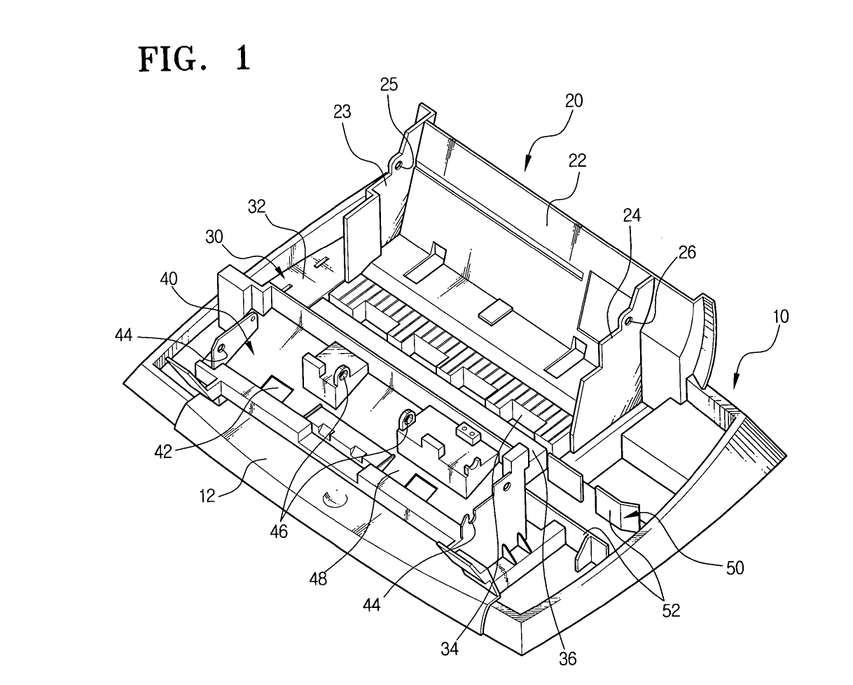

FIG. 1 shows an embodiment of a one-molding frame for a combination printer according to an embodiment of the present invention.

Referring to FIG. 1, the one-molding frame for a combination printer includes a base frame 10, a paper feed part 20, a print part 30, and a scan part 40 integrally formed in a single body.

The base frame 10 is a foundation for enabling the combination printer to be stably established at a predetermined position to print or copy and may be used as a storage part to store used ink. Accordingly, the bottom of the base frame 10 is formed to be as flat as possible. In addition, an upper surface 12 of the base frame 10 has a path formed for paper to move smoothly from the paper feed part 20 and be discharged outside the combination printer.

The paper feed part 20 is formed at one end of the base frame 10, and includes a stacking plate 22 and a pair of sidewalls 23, 24 corresponding to a frame and a stacker of a conventional paper feed module. At both side walls 23, 24 of the paper feed part 20 are feed roller holes 25, 26 so that a feed roller (not shown) to separate paper stacked in the stacking plate 22 sheet by sheet can be assembled therein.

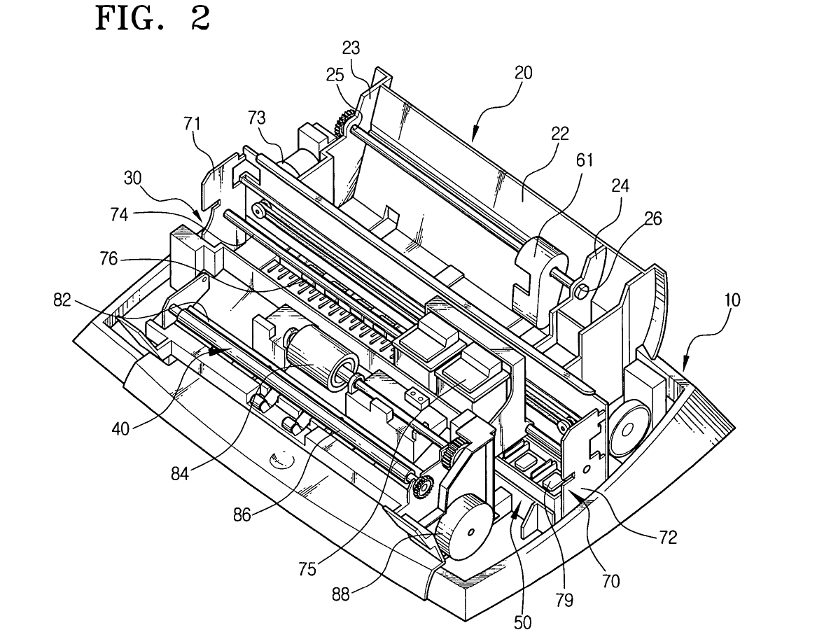

The print part 30 is formed in front of the paper feed part 20, and includes a supporting part 32 on which an inkjet head unit is disposed, and a feed roller receiving part 34 in which a feed roller 76 (FIG. 2) is disposed to convey paper fed from the paper feed part 20 to below the inkjet head 75 (FIG. 2) at regular intervals. An inkjet head unit is formed of a single sub-assembly which includes the inkjet head 75 to spray ink, a guiding bar 74 (FIG. 2) to guide the inkjet head to move left and right, and a power transmitting part to move the inkjet head left and right along the guiding bar 74, and the sub-assembly is disposed in the supporting part 32. On the upper surface 12 of the base frame facing the inkjet head, a paper supporter 36 is formed to support paper to have an image formed thereon by ink sprayed from the inkjet head 75.

At one side of the print part 30, a maintenance part 50 is formed to provide a frame in which a maintenance module is disposed. The maintenance part 50 has two fixing walls 52 protruding from the base frame 10 to be parallel with the print part 30 to fix the maintenance module, which is assembled as a sub-assembly therein. Accordingly, the inkjet head moving left and right along the guiding bar 74 of the inkjet head unit assembled in the print part 30 is positioned above the maintenance part 50. At this time, the maintenance part 50 cleans the inkjet head 75 after printing, and covers an inkjet head nozzle to prevent the ink on the ink-jet head 75 from getting dry. The maintenance part 50 is not necessarily provided if the combination printer does not have a maintenance function.

The scan part 40 is formed at the other end of the print part 30 and a scan portion forming a scan module is assembled in the scan part 40. The scan part 40 includes a scanning sensor 82 to read a document, an ADF roller 84 to pick up the document, and a white roller 86 to convey the document. The scan part 40 is formed in a box shape, and has a sensor part 42 at the bottom surface 48 and holes 46, 44 at both sides thereof to which the ADF roller 84 and the white roller 86 are assembled. The sensor part 42 has the scanning sensor 82 formed thereon for reading a document. The ADF roller 84 and the white roller 86 convey a document to the scanning sensor 82 and discharge the scanned document outside.

In addition, the scan part 40 forms a bridge shape, creating a space between the bottom surface 48 of the scan part 40 and the upper surface 12 of the base frame 10. Accordingly, the paper with an image printed thereon in the print part 30 is discharged outside the combination printer through below the bottom surface 48 of the scan part 40.

An embodiment of a combination printer with the elements described above, assembled in such a one-mold frame, is shown in FIG. 2.

Referring to FIG. 2, a pickup roller 61 is assembled in the feed roller holes 25, 26 formed in both side walls 23, 24 of the stacking plate 22 of the paper feed part 20.

On the upper side of the print part 30 and the maintenance part 50, a sub-assembled print unit assembly 70 is disposed. Both supporters 71, 72 of the print unit assembly 70 are assembled in the supporting part 32 (FIG. 1) formed at one side of the print part 30 and the maintenance part 50, respectively. The inkjet head 75 moves left and right along a guiding bar 74 by a first motor 73 assembled at one end of the print unit assembly 70. The feed roller receiving part 34 (FIG. 1), formed on the lower part of the print part 30 has the feed roller 76 assembled thereon, and the maintenance part 50 has the maintenance portion 79 assembled therein.

The sensor part 42 (FIG. 1) at the bottom of the scan part 40 has the scanning sensor 82 assembled therein, and the ADF roller 84 and the white roller 86 assembled to the scan part 40 at both sides convey a document to the scanning sensor 82 and discharge the document outside. There is a second motor 88 assembled at one side of the scan part 40 to drive the ADF roller 84 and the white roller 86 so that the document can discharged outside through the scanning sensor 82.

Albeit not shown, there may be a cover assembled on the upper surface 12 of the base frame 10. The cover has a document stacker provided thereon to stack documents and an operation board disposed thereon to control the combination printer.

The operation of the combination printer having the above-described structure will be described below.

First, in order to print a predetermined image on paper, the paper to be printed is stacked in the stacking plate 22 of the paper feed part 20. The stacked paper is then separated sheet by sheet by the pickup roller 61, and the separated paper sheet is conveyed to the feed roller 76. While the paper sheets are fed to below the print unit assembly 70 by the feed roller 76 at regular intervals, the inkjet head 75 forms a predetermined image on the paper sheets by spraying ink while being moved left and right along the guiding bar 74 by the first motor 73. The paper with the printed image is discharged outside the combination printer between the bottom surface 48 of the scan part 40 and the upper surface 12 of the base frame.

In order to copy or scan a document, the document is stacked in the document stacker of the cover (not shown). The document is separated sheet by sheet by the ADF roller 84 and conveyed to the white roller 86 and the scanning sensor 82, and the scanning sensor 82 reads the content of the document.

In the combination printer using a one-molding frame according to the embodiment of the present invention described above, a paper feed module is performed by the stacking plate 22 and the pickup roller 61. The paper feed part 20 is integrally formed with the base frame 10. The function of the print module to form a predetermined image on paper is achievable by assembling the sub-assembled print unit assembly to the supporting part 32 integrally formed with the base frame 10. Also, the function of the scan module to convey a document and read the content of the document is performed by the scanning sensor 82, the ADF roller 84 and the white roller 86 assembled in the scan part 40 integrally formed with the base frame 10.

By using a one-molding frame according to the embodiment of the present invention, there is no need to separately manufacture each frame for the paper feed module, print module, and scan module since the frames for each module are integrally formed in the base frame. Accordingly, the material costs for the total product can be reduced.

Furthermore, since there is no need to assemble each module using a separate assembly line and assemble the assembled modules to the base frame, assembly costs can also be reduced.

Therefore, manufacturing costs can be reduced as the number of assembling parts and assembling processes required for manufacturing a combination printer is reduced.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A one-molding frame for a combination printer comprising:
a paper feed module frame to support a stacker to stack a plurality of sheets of paper, separate the stacked papers sheet by sheet and feed the separated papers;
a print module frame adjacent the paper feed module frame to support an image former to form an image on the fed papers;
a scan module frame disposed adjacent to the print module frame to support a reader to read a document; and
a base frame to support the paper feed module frame, the print module frame, and the scan module frame and to form a conveyance path for the paper,
wherein the paper feed module frame, the base frame, the print module frame, and the scan module frame are integrally formed.

2. The one-molding frame for a combination printer according to claim 1, wherein the print module frame further supports an inkjet head which performs a printing on the paper by spraying ink.

3. The one-molding frame for a combination printer according to claim 2, further comprising a maintenance module frame, integrally formed with the base frame, to support a cleaner to clean the inkjet head and prevent the ink from getting dry.

4. A one-molding frame used in an inkjet combination printer comprising a pickup roller to separate stacked paper sheet by sheet and feed the separated paper, an inkjet head unit to form an image on the fed paper, and a scan part to read a document, the one-molding frame comprising:
a base frame forming a conveyance path for the paper;
a paper feed part protruding from a first end of an upper surface of the base frame to define a stacker on which plural sheets of the paper are stacked, the pickup roller being disposed thereon;
a print part adjacent to the paper feed part of the base frame, the inkjet head unit being disposed thereon; and
a scan part protruding from a second end of the upper surface of the base frame opposite the first end,
wherein the base frame, the paper feed part, the print part and the scan part are integrally formed.

5. The one-molding frame according to claim 4, further comprising a maintenance part on the print part to clean an inkjet head of the inkjet head unit and preventing ink sprayed therefrom from getting dry.

6. The one-molding frame according to claim 4, wherein the scan part is formed on the base frame in a bridge shape and the paper is conveyed between the scan part and the base frame.

7. A combination printer comprising:
a pickup roller to separate stacked paper sheet by sheet and feed the separated paper;
an inkjet head unit to form an image on the fed paper;
a scan part, adjacent to the inkjet head unit, to read a document;
a one-molding frame having a base frame, a paper feed part, a print part and a scan portion being integrally formed therein,
the base frame forming a conveyance path for the paper therein,
the paper feed part protruding from a first end of an upper surface of the base frame to define a stacker on which a plurality of the sheets of paper are stacked, the pickup roller being disposed thereon,
the print part formed adjacent to the paper feed part, the inkjet head unit being disposed thereon,
the scan part protruding from a second end of the upper surface of the base frame opposite the first end, the scan part being disposed thereon; and
a cover to cover the one-molding frame to prevent the pickup roller, the inkjet head unit, and the scan part from being exposed.

8. The combination printer according to claim 7, further comprising a maintenance part at a side of the print part, to clean an inkjet head of the inkjet head unit and prevent ink sprayed from the inkjet head from getting dry.

9. The combination printer according to claim 7, wherein the scan part is formed on the base frame in a bridge shape and the paper printed by the print part is conveyed between the scan part and the base frame.

10. An apparatus comprising:
a first unit to stack a plurality of sheets of paper, separate the stacked papers sheet by sheet and feed the separated papers;
a second unit adjacent the first unit, to form an image on the fed papers; and
a third unit adjacent the second unit, to read a document,
wherein the first, second and third units are integrally formed.

11. The apparatus according to claim 10, further comprising a base frame to support the first, second and third units.

12. The apparatus according to claim 11, wherein the base frame comprises a path to discharge the image formed papers to an outside.

13. The apparatus according to claim 10, wherein the second unit comprises an inkjet print head, and the apparatus further comprises a maintenance unit on the second unit to clean the inkjet print head.

14. An image forming apparatus comprising:
a first unit to stack sheets of paper;
a first roller, supported by the first unit, to separate and feed the stacked papers;
an inkjet unit to form an image on the fed papers;
a second unit adjacent the first unit, to support the inkjet unit;
a third unit adjacent to the second unit, to read a document; and
a base frame to support the first, second and third units,
wherein the base frame and the first, second and third units are integrally formed.

15. The apparatus according to claim 14, wherein the inkjet unit comprises:
an inkjet head to spray ink; and
a guide bar to guide the inkjet head.

16. The apparatus according to claim 14, further comprising a maintenance unit on the second unit to clean the inkjet unit.

17. The apparatus according to claim 16, further comprising a support unit on the base frame, facing the inkjet head and to support the image formed paper.

18. The apparatus according to claim 16, wherein the maintenance unit comprises a plurality of fixing walls protruding from the base frame in parallel with the second unit.

19. The apparatus according to claim 14, wherein the third unit comprises:
a sensor to scan the document;
a second roller to pick up the scanned document; and
a third roller to convey the picked-up document.
